(19) United States
(12) Patent Application Publication
(10) Pub. No.: US 2007/0266420 A1
(43) Pub. Date: Nov. 15, 2007

(54) PRIVACY MODELING FRAMEWORK FOR SOFTWARE APPLICATIONS

(75) Inventors: Jennifer Lynn Hawkins, Toronto (CA); Darshanand Khusial, Mississauga (CA); Kelly Ann Lyons, Toronto (CA); Michael J. McAllister, Hallfax (CA); Jacob Slonim, Bedford (CA); Michael Anthony Smit, Shubernacadie (CA)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/382,971

(22) Filed: May 12, 2006

(51) Int. Cl. H04L 9/00

(52) U.S. Cl. 726/1

(57) ABSTRACT

Embodiments of the present invention address deficiencies of the art in respect to privacy compliance assessment for computer software and provide a method, system and computer program product for a privacy model framework for software applications. In one embodiment, a privacy modeling data processing system can be provided. The privacy modeling data processing system can include a modeling framework configured for communicative coupling to a software application. The modeling framework can capture information flows from requests to and responses from a coupled software application, and can rules-based process the captured information flows for privacy rules to generate a privacy compliance report for the software application.

### BACKGROUND OF THE INVENTION

1. Field of the Invention

The present invention relates to the field of information technology auditing tools and more particularly to privacy information management.

2. Description of the Related Art

The modern commercial climate places a special emphasis on the privacy of information exchanged electronically over data communications networks. Legislation both within the United States and abroad subjects business owners to a multitude of privacy obligations. Consequently, business owners continually must address internal privacy and data management policies, impending and enacted legislation, industry-wide best-practices and standards, and safe harbor or privacy seal programs. The resulting cost has been staggering by all accounts.

Within the United States, recently proposed legislation mandates privacy compliance assessment and security vulnerability checking. Non-compliance will likely result in legal penalties. Yet, even in the absence of such legislation, a failure to comply with privacy obligations often can result in a tarnished reputation for an offending entity, law suits, and lost consumer confidence to name a few negative consequences. Thus, the commercial enterprise engaging in the collection of private data now faces the daunting task of applying the varied principles of privacy compliance management to its employees, agents, business processes and software in order to manage the risk of non-compliance with privacy obligations.

This compliance has sometimes been addressed by manual privacy impact assessment questionnaires. A privacy impact assessment questionnaire generally requires a business unit manager or compliance officer to answer a series of questions relating to the business processes and practices of the business unit. Areas requiring improvements can be identified so that the issues can be resolved. Yet, the process is manual, repetitive, and theoretical and will be recognized only as a measure of whether current policies are compliant and not whether the implementation of the policies complies with the policy.

Computer software lacks a means for assessing privacy compliance. Yet, in many cases, computer software can collect, store, modify, and access personal information. To test the privacy compliance of computer software, one must identify the data usage practices within software. This problem of a general-purpose privacy compliance model for computer software appears to be unaddressed in industry and academia. Notwithstanding, as more stringent laws are passed and public attention continues to grow, corporations must ensure that software systems protect individual privacy as a high priority. Although security threat models have caught on rapidly in the past few years, no general model for privacy compliance assessment has been proposed. At best, computer software is presumed to follow the privacy policies of the business process it facilitates, without confirmation in the operation of the computer software. There is no defined, structured way to ensure that software—whether it is being developed by the organization or only used—adheres to privacy policies.

### BRIEF SUMMARY OF THE INVENTION

Embodiments of the present invention address deficiencies of the art in respect to privacy compliance assessment for computer software and provide a novel and non-obvious method, system and computer program product for a privacy compliance model for software applications. In one embodiment, a data processing system configured for privacy modeling can be provided. The data processing system can include a modeling framework configured for coupling to a software application. The privacy modeling framework can include each of a capture component, an abstraction component, a context component, and an analysis component.

More specifically, the capture component can include program code enabled to capture information flows to and from the software application. For instance, the capture component can include program code enabled to provide a filter for input and output from the software application. The abstraction component in turn can include program code enabled to abstract descriptors for data elements in an information flow captured by the capture component from the software application to an abstracted label for the data elements. The context component can include program code enabled to discover a privacy policy or a set of privacy policies for the software application. Finally, the analysis component can include program code enabled to produce a report of privacy compliance information determined from the information flow.

In another embodiment of the invention, a method for privacy modeling a software application can be provided. The method can include capturing information flows from input to and output from a coupled software application, and using pre-defined privacy rules to rules-based process the captured information flows to generate a privacy compliance report for the software application. The method can include determining a privacy policy for the software application and producing the privacy report based upon the determined privacy policy.

The method further can include abstracting descriptors for data elements in the information flows to produce abstracted labels for the data elements. In this regard, abstracting descriptors for data elements in the information flows to produce abstracted labels for the data elements can include mapping the descriptors to corresponding abstracted labels based upon a pre-established table of mappings. Alternatively, abstracting descriptors for data elements in the information flows to produce abstracted labels for the data elements can include dynamically mapping the descriptors to corresponding abstracted labels based upon a set of keywords, a set of synonym sets and a thesaurus. Finally, abstracting descriptors for data elements in the information flows to produce abstracted labels for the data elements, further can include assigning a level of sensitivity to the data elements.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a data processing system configured for privacy compliance assessment for software applications;

FIG. 2 is a block diagram illustrating a specialization hierarchy for a privacy modeling framework; and,

FIG. 3 is an event diagram illustrating a process for performing privacy compliance assessment for a software application.

### DETAILED DESCRIPTION OF THE INVENTION

Embodiments of the present invention provide a method, system and computer program product for privacy compliance management for computer software. In accordance with an embodiment of the present invention, information flows to and from a component of a software application can be captured and abstracted to a uniform way to reference the data elements. Additionally, a context and privacy policies for the component can be discovered. Thereafter, the information flows can be assessed for compliance with the retrieved privacy policies. For instance, the analysis can include a rules-based evaluation of the information as it compares to the privacy rules with which the application must comply. Finally, a privacy compliance report can be produced for the analysis and the analysis can be rendered in a display view for review by an end user.

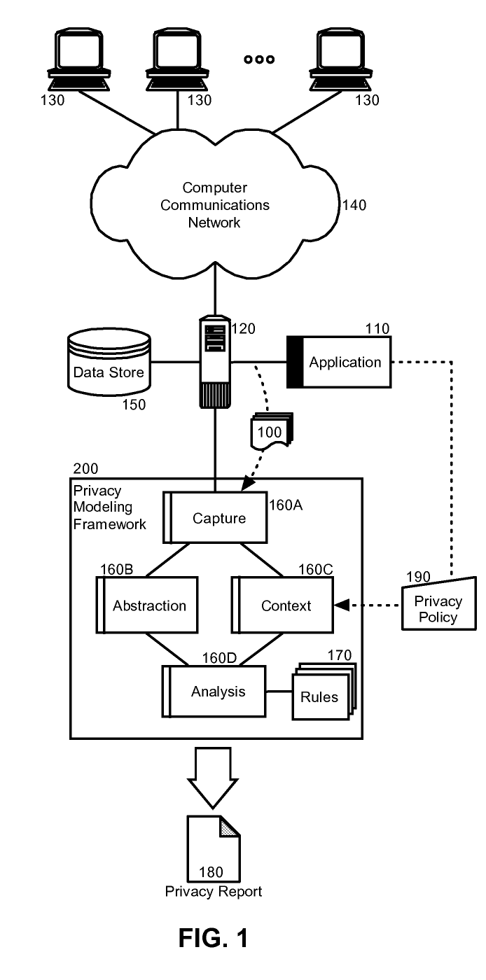

In further illustration, FIG. 1 is a schematic illustration of a data processing system configured for privacy compliance assessment for software applications. The system can include a computing platform 120 configured to host the operation of a software application 110 for access by one or more client computing sessions 130 over a computer communications network 140. The software application 110 can include program logic enabled to receive data input from individual ones of the client computing sessions 130, to store the information in a communicatively coupled data store 150, to retrieve information from the coupled data store 150, to modify or access the information internally, to transmit the information to third-party programming logic, and/or to provide information to the client computing sessions 130. The software application 110 further can include a conventional client-server application, or even a set of application components implementing a service oriented architecture.

A privacy modeling framework 200 can be communicatively coupled to the software application 110. The privacy modeling framework 200 can include a collection of logic components arranged to observe and analyze for compliance with a privacy policy 190, information flows 100 into and out from the software application 110, including inflow and outflow between the software application 110 and the data store 150. The logic components can include a capture component 160A, an abstraction component 160B, a context component 160C and an analysis component 160D.

In more detail, the capture component 160A can include program code enabled to capture information as it flows into and out from the software application 110. The information can be observed in communication flows between the client computing sessions 130 and the software application 110. The information further can be observed in communication flows between the software application 110 and the data store 150. The information further can be observed in communication flows between the software application 110 and third party logic (not shown).

For example, the capture component 160A can be a component filter programmed to capture request and response objects for processing, including server page templates arranged to render data in a visual display. In the former circumstance, the filter can extract from request objects information flows from the end user. In the latter circumstance, the filter can extract from the rendered server template page the information as formatted for presentation to an end user. The rendered page can be compared to the server template page to identify the information particular to that end-user.

The abstraction component 160B can include program code enabled to abstract descriptors of data elements in the software application 110 in order to provide a uniform way to reference the data elements, irrespective of the underlying descriptors applied to the data elements. For instance, the program code of the abstraction component 160B can recognize different descriptors applied to a single data element at different places in a software application.

Thereafter, the program code of the abstraction component 160B can identify a corresponding abstracted label for the data element as pre-established within a mapping for the descriptor, or as dynamically mapped by reference to a list of keywords, a set of synonyms for the descriptor, or a thesaurus. Generally, the abstracted data labels can describe a broad category encompassing different data element descriptors. For instance, the program code of the abstraction component 160B can recognize different data element descriptors as being “demographic” data or “user preferences” data and can assign an appropriate abstracted data label.

As an example, the mapping can include a table of associations between labels for a data element and an abstracted label. Optionally, the table can include regular expressions enabled to resolve a label for a data element into an abstracted label. As yet a further option, the application of the mappings can be chained to transform an initial label for a data element into one or more intermediate labels before a final transformation into the abstracted label. In this way, the scale of a privacy model for the software application 110 can be reduced to the abstracted form of the data elements in the software application 110.

The program code of the abstraction component 160B yet further can resolve the descriptor of a data element to a level of sensitivity. In this instance, the level of sensitivity can refer to the degree of importance with regard to privacy of a particular data element. Consequently, the sensitivity of the data elements assigned by the program code of the abstraction component 160B can address the differentiated importance of different data elements depending upon the nature of the individual data elements. As in the case of providing an abstracted data label, in the case of assigning a sensitivity to a data element, the sensitivity can be determined by way of a pre-established mapping, or by way of a dynamic mapping according to a list of keywords, a set of synonym sets or a thesaurus, to name only a few.

The context component 160C can include program code which can supply the privacy policy 190 of a portion of a software application 110 including the software application 110 in its entirety. The context as used herein includes the privacy policies 190 associated with the software application 110. The privacy policies 190 can include use, notice, retention and security policy for the software application 110. Additionally, the privacy policies 190 can include several different privacy policies intended for different circumstances, such as the use of the software application 110 in different political jurisdictions where the pertinent privacy policy may vary. In any event, the context component 160C can ascertain one or more privacy policies 190 of the software application 110 in a pre-programmed or dynamic way.

For example, the context component 160C can read pre-programmed privacy policies of the software application, or the context component 160C can obtain the privacy policy through a questionnaire completed by the administrator. In any case, the context component 160C can produce a privacy practices document, preferably in the Enterprise Privacy Authorization Language (EPAL) format. Finally, the analysis component 160D can include program code enabled to process the abstracted data elements produced by the abstraction component 160B in light of the privacy context produced by the context component 160C in order to produce a privacy compliance report 180.

In one aspect of the invention, the analysis component 160D can compare the flow of information in the software application with a set of privacy rules 170 in order to report those information flows 100 that comply with the privacy rules 170 and those information flows 100 in the software application 110 that do not comply with the privacy rules 170. The comparison of the privacy rules 170 can include the evaluation of one of many rules 170 in a privacy policy on the flow of information on a rule by rule basis. The report 180 produced by the analysis component 160D can indicate which privacy rules 170 of a privacy policy for the software application have been violated and which have not. The report can be provided visually, or the report can be provided in markup format suitable for use as input to programmatic logic.

In addition, the analysis component 160D can rate or rank identified privacy vulnerabilities in order of priority based upon the sensitivity of the information at risk, the severity of the violation, the likelihood of occurring, and likelihood of being detected, to name a few examples. In any event, utilizing the privacy report 180, potential violations of the privacy rules can be identified within the software application 110 regardless of the stated privacy policy 190 of the software application 110.

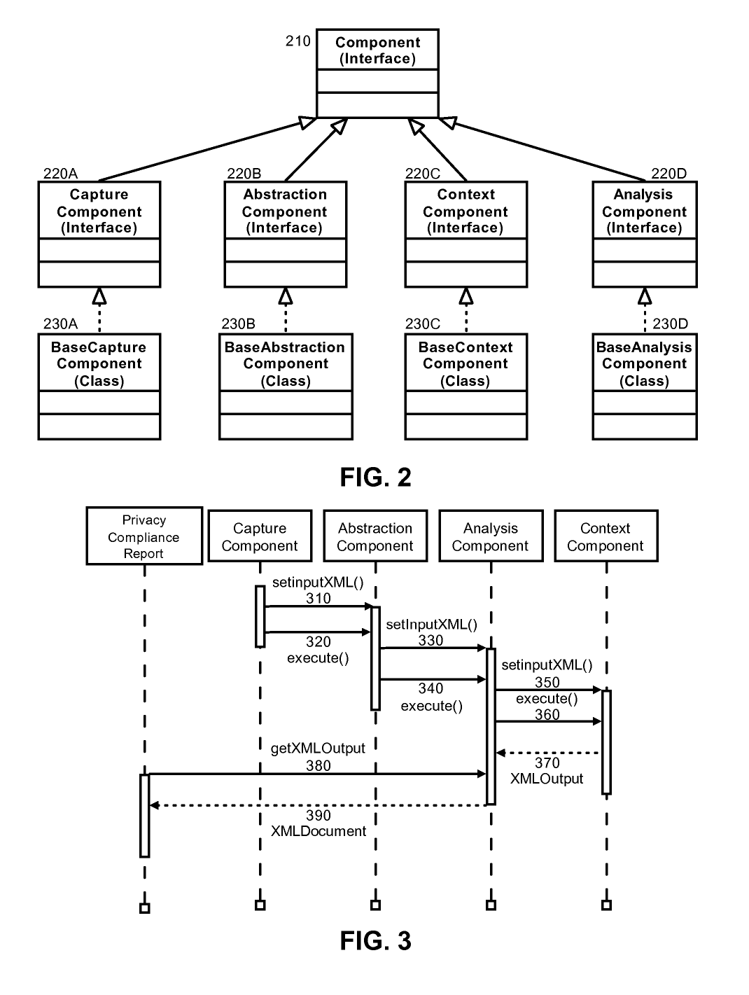

The logic components of the privacy modeling framework 200, can implement respective interfaces specializing a common component interface. In further illustration, FIG. 2 is a block diagram illustrating a specialization hierarchy for a privacy modeling framework. As shown in FIG. 2, each of the capture component interface 220A, abstraction component interface 220B, context component interface 220C and the analysis component interface 220D can specialize a component interface 210. A context capture component class 230A, abstraction component class 230B, component class 230C and the analysis component class 230D in turn can implement the capture component interface 220A, abstraction component interface 220B, context component interface 220C and the analysis component interface 220D, respectively.

In yet further illustration, FIG. 3 is an event diagram illustrating a process for performing privacy compliance assessment for a software application utilizing the components of FIG. 2. Initially, a capture component can capture an information flow and in path 310 can provide the information flow to the abstraction component. Thereafter, the capture component in path 320 can execute the abstraction process on the information flow in the abstraction component. Responsive to the execution request from the capture component, the abstraction component can abstract the data elements in a modified information flow and provide the same to the analysis component in path 330. Subsequently, the abstraction component can execute the analysis process on the modified information flow in path 340.

When the analysis component receives a directive to perform an analysis on an information flow modified by the abstraction component, the analysis component can perform a privacy compliance assessment on the modified information flow. Optionally, the analysis component in path 350 can provide the modified information flow to the context component and invoke the execution of the context process in path 360. The context component in turn can provide a context to the modified information flow based upon the privacy policy of the modeled software application. Upon completion, in path 370 a result set can be provided to the analysis component. Once the analysis component has completed its analysis is converted into a privacy compliance report in path 390 in response to a request for output in path 380.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A data processing system configured for privacy modeling, the system comprising:
a modeling framework configured for coupling to a software application, the modeling framework comprising each of a capture component, an abstraction component, a context component, and an analysis component.

2. The system of claim 1, wherein the capture component comprises program code enabled to capture information flows selected from the group consisting of flows to and from the software application, flows to and from a data store for the software application, and flows to and from third party logic communicatively coupled to the software application.

3. The system of claim 1, wherein the capture component comprises program code enabled to provide a filter for requests and responses processed by the software application.

4. The system of claim 1, wherein the abstraction component comprises program code enabled to abstract descriptors for data elements in an information flow from the software application to an abstracted label for the data elements.

5. The system of claim 4, wherein the abstraction component further comprises program code enabled to determine a level of sensitivity for each of the data elements in the information flow.

6. The system of claim 1, wherein the context component comprises program code enabled to determine a privacy policy for the software application.

7. The system of claim 1, wherein the analysis component comprises program code enabled to produce a privacy report of privacy compliance information determined from the information flow.

8. The system of claim 6, wherein the analysis component comprises program code enabled to rules-based compare the information flow with privacy rules of the determined privacy policy provided by the context component.

9. A method for privacy modeling software application logic, the method comprising:
capturing information flows to and from a communicatively coupled software application logic; and,
rules-based processing the captured information flows for privacy rules to generate a privacy report for the software application logic.

10. The method of claim 9, further comprising abstracting descriptors for data elements in the information flows to produce abstracted labels for the data elements.

11. The method of claim 10, wherein abstracting descriptors for data elements in the information flows to produce abstracted labels for the data elements, comprises mapping the descriptors to corresponding abstracted labels based upon a pre-established table of mappings.

12. The method of claim 10, wherein abstracting descriptors for data elements in the information flows to produce abstracted labels for the data elements, comprises dynamically mapping the descriptors to corresponding abstracted labels based upon one of a set of keywords, a set of synonym sets and a thesaurus.

13. The method of claim 10, wherein abstracting descriptors for data elements in the information flows to produce abstracted labels for the data elements, further comprises assigning a level of sensitivity to the data elements.

14. The method of claim 9, further comprising determining a privacy policy and privacy practices for the software application and producing the privacy report measuring compliance with the privacy policy.

15. The method of claim 9, further comprising determining a privacy policy and privacy practices for the software application and producing the privacy compliance report applying a rating to each privacy rule in the privacy policy and assessing a relative importance of each rule of the privacy policy.

16. A computer program product comprising a computer usable medium having computer usable program code for privacy modeling software application logic, the computer program product including:
computer usable program code for capturing information flows from requests to and responses from communicatively coupled software application logic; and,
computer usable program code for rules-based processing the captured information flows for privacy rules to generate a privacy report for the software application logic.

17. The computer program product of claim 16, further comprising computer usable program code for abstracting descriptors for data elements in the information flows to produce abstracted labels for the data elements.

18. The computer program product of claim 17, wherein the computer usable program code for abstracting descriptors for data elements in the information flows to produce abstracted labels for the data elements, comprises computer usable program code for mapping the descriptors to corresponding abstracted labels based upon a pre-established table of mappings.

19. The computer program product of claim 17, wherein the computer usable program code for abstracting descriptors for data elements in the information flows to produce abstracted labels for the data elements, comprises computer usable program code for dynamically mapping the descriptors to corresponding abstracted labels based upon one of a set of keywords, a set of synonym sets and a thesaurus.

20. The computer program product of claim 17, wherein the computer usable program code for abstracting descriptors for data elements in the information flows to produce abstracted labels for the data elements, further comprises computer usable program code for assigning a level of sensitivity to the data elements.

21. The computer program product of claim 16, further comprising computer usable program code for determining a privacy policy for the software application and producing the privacy report measuring compliance with the privacy policy.

22. The computer program product of claim 16, further comprising computer usable program code for determining a privacy policy and privacy practices for the software application and producing the privacy compliance report applying a rating to each privacy rule in the privacy policy and assessing a relative importance of each rule of the privacy policy.
